(19) United States
(12) Patent Application Publication
(10) Pub. No.: US 2005/0203214 A1
(43) Pub. Date: Sep. 15, 2005

(54) Surface modified inorganic oxide powder and its use

(75) Inventors: Yuki Amano, Yokkaichi-shi (JP); Hirokuni Shirono, Yokkaichi-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: NIPPON AEROSIL CO., LTD., Tokyo (JP)

(21) Appl. No.: 10/632,792

(22) Filed: Aug. 4, 2003

(30) Foreign Application Priority Data
Dec. 14, 2001 (JP) 2001381914

(51) Int. Cl. C08K 3/10

(52) U.S. Cl. 523/212; 524/434; 524/437; 524/493; 524/556

(57) ABSTRACT

[Problem to be Solved]: To provide a surface modified inorganic oxide powder having a reduced amount of residual volatile components. [Solution]: The surface modified inorganic oxide powder is obtained by the surface treatment of an inorganic oxide powder with the use of a treating solution of long-chain alkylsilane and catalysts in a solvent or by the heat treatment of the inorganic oxide powder between the volatilization temperature of the organic volatile components and the decomposition temperature of the treating agents after the surface modification, to reduce the amount of the volatile components to less than 30 ppm, preferably less than 10 ppm. And this surface modified inorganic oxide powder is suited in use as the additive for powder coating materials, toners for electrophotography or the like; the viscosity modifier for the resin of an adhesive, a coating material or the like; the reinforcing filler for natural rubber, synthetic rubbers, engineering plastics or the like; the anti-block agent for films of polyethylene, polyester or the like; and the adhesive and sealant for various resins.

### BACKGROUND OF THE INVENTION

1. Technical Field of the Invention

The present invention relates to a high hydrophobicity surface modified inorganic oxide powder having remarkably reduced amount of residual volatile components. The inorganic oxide fine powder has been used as an additive for powder coating materials, toners for electphotography or the like; a viscosity modifier for an adhesive, coating materials or the like; a reinforcing filler for natural rubber, synthetic rubbers, engineering plastics or the like; an anti-block agent for films of polyethylene, polyester or the like; and the filler for the adhesive, sealant or the like. As for these inorganic oxide powders, the present invention relates to the high hydrophobicity surface modified inorganic oxide fine powder having the remarkably reduced amount of the residual volatile components after the surface modification. The surface modified inorganic oxide fine powder of the present invention is especially useful in the use in which there are problems at the time of generating a volatile compound.

2. Discussion of the Prior Art

The inorganic oxide powder, such as silica, titania, alumina or the like, has been used over a wide range of the fields, such as the additive for powder coating materials, toners for electphotography or the like; the viscosity modifier of resins for the adhesive, the coating materials or the like; the reinforcing filler for natural rubber, synthetic rubbers, engineering plastics or the like; and the anti-block agent for films of polyethylene, polyester or the like.

It has been carried out that these inorganic oxide fine particles are given further various functional characteristics by the surface modification treatment. More particularly, for example, the inorganic oxide fine powders being surface modified with the use of a coupling agent or a polymer, has been used. As the surface treating agent being widely used in general, an alkylsilane compound, a silicone oil or the like, have been used.

Problems to be Solved

As for the conventional surface modified inorganic oxide powder, since the treating agent for surface modifying is remained on the powder surface and is volatilized, there are often problems. An oligomer having a low molecular weight is contained in the general silicone oil, and when such silicone oil is used as the surface treating agent, the oligomer having the low molecular weight is remained on the powder surface. Moreover, the oligomer having the low molecular weight may be generated and remained by the reaction at the time of the surface modification. Such an oligomer having the low molecular weight has a relatively low boiling point, and is easily volatilized at the time of using or with the storage environment, so that there are problems.

For example, when the inorganic oxide powder having the residual volatile compound is kneaded and dispersed with the resin, bubbles are generated at the time of the heating up, so that the resin becomes a cured resin containing the bubbles. Moreover, when the inorganic oxide powder having the residual volatile compound is used as the additive for the toners for electrophotography, there is a problem that the volatile components are generated and pollute the inside of a transfer drum in a copying machine since the temperature becomes high at the time of the transfer. Furthermore, when the inorganic oxide powder having the residual volatile compound is used as the resin composite, such as the adhesive, there is a problem that the volatile components cause a spark and generate the problems, such as a failure in a point of contact.

In order to correspond the above problems, it has been provided that the inorganic oxide powder is washed after the surface modification by using an organic solvent (Japanese Patent Laid Open No. H10-316406). However, when the fine particles are dispersed in the solvent, the fine particles are agglomerated each other even when said particles are fully dried, and as the result, the functions of the fine particles are damaged. In addition, in order to pulverize the agglomeration to be classified, the labor is required and the cost becomes high.

The present invention solves the above problems in the conventional surface modified inorganic oxide powder, and provides the inorganic oxide fine powder having excellent thickening at the time of blending with the polar resin, such as epoxy resin etc. and stability with the passage of time, since the powder has the remarkably reduced amount of the residual volatile components.

Means to Solve the Problems

The present invention relates to (1) the surface modified inorganic oxide powder, wherein the amount of residual volatile organic components is less than 30 ppm.

The powder of the present invention is, for example, (2) the surface modified inorganic oxide powder, wherein the amount of the residual volatile organic components is reduced to less than 30 ppm by the heat treatment after the surface modification at a temperature of from higher than the volatilization temperature of the organic volatile components to lower than the decomposition temperature of a treating agent for surface modifying. More particular, said powder is, for example, (3) the surface modified inorganic oxide powder, wherein the volatile components on the powder surface are removed by the heat treatment at from higher than 200 degree C. to lower than 400 degree C. at the time of a surface treatment and the further heat treatment at from higher than 150 degree C. to lower than 400 degree C.

In addition, the powder of the present invention is, for example, (4) the surface modified inorganic oxide powder, wherein the amount of the residual volatile organic components is reduced to less than 30 ppm by the surface treatment with the use of the treating agent obtained by dissolving a long-chain alkylsilane together with a catalyst. More particular, said powder is, for example, (5) the surface modified inorganic oxide powder, wherein the surface treatment is carried out with the use of the treating agent in which the long-chain alkylsilane having more than 16 carbons is dissolved and diluted together with an amine catalyst, and (6) the surface modified inorganic oxide powder, wherein the surface treatment is carried out with the use of the treating agent obtained by diluting the long-chain alkylsilane from 2 to 6 times, and (7) the surface modified oxide powder, wherein the surface treatment is carried out by existing the treating agent on the surface of the inorganic oxide powder and heating at higher than 200 degree C.

The surface modified inorganic powder of the present invention is (8) the surface modified inorganic oxide powder, wherein the amount of the residual volatile organic components is less than 10 ppm.

(9) The surface modified inorganic powder of the present invention includes the surface modified inorganic oxide powder, wherein said inorganic oxide powder is silica, titania, alumina, or composite oxide particles comprising one or more these oxides, and (10) the surface modified inorganic oxide powder, wherein the surface treatment is carried out with the use of at least one alkylsilane represented by the following formula [1], [2], [3], or [4]. 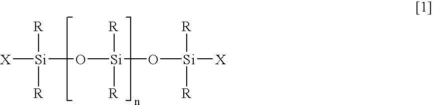
Where, R represents a hydrogen atom or an alkyl group which may be optionally substituted partially by a vinyl group, a phenyl group, a polyether group, a epoxy group or an amino group, and R bonding to each Si may be same or different, and X represents the R, a halogen atom, a hydroxyl group or a hydrolyzable alkoxy group. n represents an integer of 15 to 500.
RSiX₃ [2]
R¹R²SiX₂ [3]
R¹R²R³SiX [4]
Where, R represents an alkyl group, and X represents a halogen atom, a hyroxyl group, or an alkoxy group R¹, R², and R³ in formula [3] and [4], may be same or different. At least one of these alkyl groups has more than 6 carbons preferably.

Furthermore, the present invention relates to (11) a polar resin composite, obtained by mixing a urethane resin, an epoxy resin, an acrylic resin, an unsaturated polyester resin, a vinyl ester resin, or a silicone modified resin with the surface modified inorganic oxide powder according to any one of from above [1] to [10], wherein the content of said powder is less than 50% by weight, and (12) the polar resin composite material wherein said material is used as an adhesive or a sealant.

The surface modified inorganic oxide powder of the present invention has the excellent stability with the passage of time, since said powder has the remarkably reduced amount of the residual volatile components, and is suited in use as the additive for powder coating materials, toners for electrophotography or the like; the viscosity modifier for the adhesive, the coating material or the like; the reinforcing filler for natural rubber, synthetic rubbers, engineering plastics or the like; the anti-block agent for films of polyethylene, polyester or the like; and the filler for the adhesive, sealant or the like.

### DETAILED DESCRIPTION OF THE PREFERRED EMBODIMENT

Hereinafter, the present invention will be explained concretely with the preferred embodiment.

The inorganic oxide powder of the present invention is the surface modified inorganic oxide powder, in which the amount of the residual volatile organic components is less than 30 ppm. Said powder is, for example, (A) the surface modified inorganic oxide powder, in which the amount of the residual volatile organic components is reduced to less than 30 ppm by the surface treatment with the use of the treating agent obtained by dissolving the long-chain alkylsilane together with the catalyst, and (B) the surface modified inorganic oxide powder, in which the amount of the residual volatile organic components is reduced to less than 30 ppm by the heat treatment after the surface modification at the temperature of from higher than the volatilization temperature of the organic volatile components to lower than the decomposition temperature of the treating agent for surface modifying.

It is available that the inorganic oxide powder is the inorganic oxide, such as silica, almina, titania or the like, or the composite oxide particles comprising one or more these oxides. These inorganic oxide powders are synthesized by any one of a wet process and a dry process. In addition, as the inorganic oxide synthesized by the dry process, for example, a silica powder produced by a flame hydrolysis of a volatile silicon compound, a titanium oxide powder produced by the flame hydrolysis of a titanium compound, or an almina powder using an aluminum compound as a raw material, can be suitably used.

As the concrete silica powder, fumed silica having the specific surface area of less than 500 m²/g by the nitrogen adsorption method (BET) (AEROSIL 50, 90G, 130, 200, 300, 380, 380S or the like, produced by Nippon Aerosil Co. ltd., or TT600 or OX50 produced by Degussa Corporation), the titanium oxide powder by the dry process (P25, produced by Nippon Aerosil Co. ltd.), the almina powder (Al₂O₃—C, produced by Degussa Corporation), or an alumina—silica mixted powder (MOX80, MOX170, COK84, produced by Degussa Corporation), can be used in the present invention.

After adding water to the above inorganic oxide powders if necessary, the surface treatment is carried out with the use of the treating agent obtained by dissolving the long-chain alkylsilane together with the catalyst. It is preferable that said long-chain alkylsilane used as the treating agent for surface modifying has more than 16 carbons. As for the inorganic oxide powder treated with the use of the long-chain alkylsilane having much carbons, the hydrophobicity is higher than that of the powder treated with the use of a short-chain alkylsilane having about less than 10 carbons, and the thickening effect is also high. Moreover, since the hydrophobicity is high, there is a little water adsorption, so that the stability with the passage of time is excellent.

As the treating agent for surface modifying, the agent obtained by dissolving said long-chain alkylsilane together with the catalyst is used. As the catalyst, amines, such as triethylamine, diethylamine, ethylenediamine or the like, or acetic acid can be used. A hydrolysis reaction of alkylsilane is advanced by using the long-chain alkylsilane together with these catalysts, and the fixing of said alkylsilane to the surface of the inorganic oxide powder can be promoted.

Furthermore, as the treating agent for surface modifying, the agent, in which the long-chain alkylsilane is dissolved together with the amine catalyst in a solvent and is diluted from 2 to 6 times, is preferably. The solvent is selected with a kind of the alkylsilane. As the solvent, for example, hexane, toluene, alcohols, ether or the like, can be used, wherein the long-chain alkylsilane can be easily dissolved. The viscosity of the treating agent is decreased with the use of the diluted long-chain alkylsilane, so that said agent can be uniformly adhered on the powder surface at the time of spraying onto the inorganic oxide powder.

It is preferable that the surface modification treatment using said treating agent is carried out under a nitrogen atmosphere. Moreover, it is preferable that said treating agent is existed on the surface of the inorganic oxide powder and is heated at more than 200 degree C. In addition, as the method for existing the treating agent on the surface of the inorganic oxide powder, the suitable method can be used, such as the treating agent is sprayed or the inorganic oxide powder is dipped in a solution of the treating agent. The bonding reaction of the treating agent with the surface of the inorganic oxide can be promoted by carrying out the heat treatment. It is suitable that the heat temperature is from higher than 200 degree C. to lower than 400 degree C. If said temperature is about 150 degree C., the bonding reaction is sometimes insufficient. Moreover, if said temperature is higher than 400 degree C., the bonded alkylsilane may be decomposed.

As described above, by the surface treatment with the use of the treating solution of the long-chain alkylsilane together with the catalyst in the solvent, it is possible to obtain the surface modified inorganic oxide powder, in which the amount of the volatile components is less than 30 ppm, preferably less than 10 ppm, for example, at the time of heating at 150 degree C.

The present invention also relates to the surface modified inorganic oxide powder, in which the volatile components are removed by the heat treatment after the surface modification at the temperature of from higher than the volatilization temperature of the volatile components to lower than the decomposition temperature of the treating agent for surface modifying, other than the powder using said surface treating agent. That is, after the surface modification treatment, the heat treatment is carried out by removing the organic volatile components and fixing the surface treating agent on the powder surface. More particularly, for example, the surface treatment is carried out by existing the treating agent on the surface of the inorganic oxide powder, heating at from higher than 200 degree C. to lower than 400 degree C., bonding the treating agent with the surface of the inorganic oxide powder, and further heating at from higher than 150 degree C. to lower than 400 degree C. to remove the residual volatile components on the powder surface.

By carrying out the surface treatment and the following two stages heat treatments, the residual volatile components, for example, the solvent, such as hexane, methanol, ether or the like, the surface modifying agent, and the decomposed substance or condensate of the solvents or agents, can be reduced to less than 30 ppm, preferably less than 10 ppm. In addition, in order to increase the efficiency of removing the volatile components, it is preferable that an inert gas, such as nitrogen, helium, argon or the like, is introduced into a reaction vessel to substitute the inside space of the vessel.

Moreover, it is preferable that the second heat treatment is carried out after the surface modification without washing with the organic solvent.

The temperature of the second heating depends a little on the surface treating agent, but is preferable to be about from 150° C. to 400° C. If the temperature is lower than 150 degree C., it is difficult to fix chemically the surface treating agent on the surface of the inorganic oxide powder. Moreover, if the temperature is higher than 400 degree C., the surface modifying agent may be decomposed, so that the inorganic oxide powder may be colored to yellow, and further, its functions may be remarkably decreased.

In the two stages heat treatments are carried out, organopolysiloxane represented by the following formula [1] can be used as the surface treating agent. 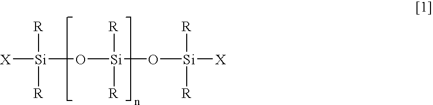
Wherein R represents a hydrogen atom or an alkyl group which may be optionally substituted partially by a vinyl group, a phenyl group, a polyether group, an epoxy group or an amino group. R bonding to each Si may be same or different. X represents the R, a halogen atom, a hydroxyl group, or a hydrolysable alkoxy group. n represents an integer of 15 to 500. By the surface modification with the use of the organopolysiloxane, it is possible to obtain the inorganic oxide powder which has good dispersibility, thickening effect and stability with the passage of time when it is added to the resin.

Moreover, the silane compound represented by the following formula [2], [3], or [4], can be used as the surface treating agent. By using these silane compounds, it is possible to obtain the surface treated inorganic oxide powder with low cost. And it gives good flowability and stability with the passage of time.
RSiX₃ [2]
R¹R²SiX₂ [3]
R¹R²R³SiX [4]
Wherein, R represents an alkyl group. X represents a halogen atom, a hyroxyl group, or an alkoxy group. R¹, R², and R³ in formula [3] and [4] may be same or different. At least one of them has more than 6 carbons preferably.

It is available that two or more compounds represented by the general formula from [1] to [4] are used in combination. Especially, it is possible to increase the effect of the surface modification and the stability with the passage of time when the inorganic powder is treated with a mixture of [1] and any one of the [2], [3], or [4], with existence of the catalyst. Anmonia or amines, such as diethylamine, triethylamine, or the like are suitable as basic catalysts. An organic acid such as acetic acid, or an inorganic acid, such as hydrochloric acid or nitric acid, is suitable as acidic catalysts.

The treatment method of the metallic oxide fine powder with the treating agent is not limited. Conventional methods can be used. More concretely, for example, the method is comprising, taking the inorganic oxide fine powder into the vessel having a stirring device being represented by Henschel mixer or the like, stirring under the nitrogen atmosphere, spraying the surface modifying agent or the mixed solution of the surface modifying agent into the vessel, mixing the inorganic oxide fine powder, heating to react. The other method is comprising, introducing the inorganic oxide fine powder into a fluidized bed reactor, mixing the vaporized alkylsilazane compound or the other mixed surface modifying agent with the inorganic oxide fine powder, and heating to react.

Effectivness of the Invention

The inorganic oxide powder of the present invention, which has reduced organic volatile components, is suitably used as the additive for powder coatings, the toners for electrophotography or the like; the viscosity modifier of resins for the adhesive, the coating material or the like; the reinforcing filler for natural rubber, synthetic rubbers, engineering plastics or the like; and the anti-block agent for films of polyethylene, polyester or the like. Moreover, said inorganic oxide powder can be used as the additive for the adhesive or the sealant by blending with a urethane resin, an epoxy resin, an acrylate resin, an unsaturated polyester resin, a vinylester resin, or a silicone modified resin. It is suitable that the amount of the surface modified inorganic oxide powder is less than 50% by weight if it is added to resins.

In the above uses, since the inorganic oxide powder of the present invention has the reduced organic volatile component, when said powder is used as the additive for the toners for electrophotography, the pollution of the drum with the volatile components can be reduced. When said powder is used as the viscosity modifier for the adhesive, the coating material or the like, the various problems by the generation of the volatile component, such as the deteriorating in function, the decreasing stability of the passage of time, the generation of the bubble, can be inhibited. Moreover, when said powder is used as the composite for electrophotography, the problems by the volatile components, such as the spark, the failure in a point of contact, or the like are not occurred.

### EXAMPLE AND COMPARISON EXAMPLE

The present invention will be explained concretely with examples. The volatile components, the viscosity, and the hydrophobicity were measured by the following processes respectively. In addition, the results of examples 1 to 3 and comparison examples 1 to 3 were shown in Table 1 with their treatment conditions. Moreover, the results of examples 4 to 7 and comparison examples 4 to 6 were shown in Table 2 with their treatment conditions.

[Volatile Components] 0.2 g of the surface modified inorganic oxide powder was measured into a vial. While heating the vial at 150° C. for 10 minutes, the volatile components were measured by using a gas-measuring apparatus (Head Space GC-MS Q910, produced by Perkin-Elmer Corporation).

[Viscosity] 7.5 g of the surface modified inorganic oxide powder was mixed with 142.5 g of the epoxy resin (Epikote 828, produced by Japan Epoxy Resins Co. Ltd.) and the mixture was stirred at 3000 rpm for 3 minutes by a homomixer (produced by Tokushukika Kogyo KK). After that, the mixture was degassed and preserved at 22 degree C. for 2 hours. Then, the viscosity was measured at 1/s using a Rheometer (RS150, produced by HAAKE Corporation). The thixotropic value is obtained from the ratio of the values of 1/s and 100/s ([1/s/[100/s]).

[Hydrophobicity] 1 g of the surface modified inorganic oxide powder and 100 g of the distilled water were taken into a 200 ml separating funnel It was shaken for 10 minutes by using a tumbler mixer (T2C type produced by Willy A. Baschofn Corporation), and preserved for 10 minutes. After that, the liquid extracted from the lower part was taken into a 10 ml quartz cell. By suing a spectrometer, the hydrophobicity (%) was determined by the measured value of the transparency of wave length of 500 nm light, where the pure water was used as a blank.

### Example 1

100 g of a silica powder produced by a vapor phase method (the specific surface area was 200 m²/g by the BET method, a product name was Aerosil 200) was taken into the reaction vessel, and while stirring under the nitrogen atmosphere, 3 g of water was sprayed onto the 100 g of the silica powder. Next, the mixed solution (surface treating agent) comprising 30 g of octadecyltrimethoxysilane, 1 g of diethylamine, and 60 g of hexane was also sprayed. After stirring at 200 degree C. for one hour, it was heated and stirred for further one hour while flowing the nitrogen. After the reaction, said powder was cooled down. Then, the surface modified fine silica powder was prepared.

### Examples 2, 3

In Example 2, the surface treatment was carried out by the same process as Example 1 excepting; using the silica powder produced by the vapor phase method (the specific surface area was 130 m²/g by the BET method, the product name was Aerosil 130), hexadecyltrimethoxysilane, and diethylamine, in which these amounts were shown in Table 1; and setting the heat treatment temperature to 200 degree C. In Example 3, the surface treatment was carried out by the same process as Example lexcepting; using the silica powder produced by the vapor phase method (the specific surface area was 300 m²/g by the BET method, the product name was Aerosil 300), hexadecyltrimethoxysilane, and ethylenediamine, in which these amounts were shown in Table 1; and setting the heat treatment temperature to 300 degree C.

### Comparison Examples from 1 to 3

In Comparison example 1, the silica powder was surface treated by the same process as Example 1 excepting; using hexyltrimethoxysilane having the short alkyl chain; and not adding the catalyst. In Comparison example 2, the surface treatment was carried out by the same process as Example 1 excepting; using hexadecyltrimethoxysilane; not adding the catalyst; and setting the treating temperature to 120 degree C. In Comparison example 3, the surface treatment was carried out by the same method as Example 1 excepting; using dimethylpolysiloxane as the treating agent; not adding the catalyst; and setting the treating temperature to 300 degree C.

As shown in Table 1, as for the surface modified silica powders of from Examples 1 to 3 of the present invention, the hydrophobicity was more than 99%, the amount of the volatile components was less than 1 ppm, and the viscosity at the time of blending with the resin was more than about 300 Pa·s (297 Pa·s). On the other hand, as for the surface modified silica powder having the short alkyl chain of Comparison example 1, the hydrophobicity was not so high, and the viscosity was low. Moreover, in the case of Comparison example 2, since the treating temperature was low and the treating agent was not sufficiently fixed on the surface of the powder, the hydrophobicity was remarkably low, there is the much amount of the residual volatile components, and the viscosity was low. In the case of Comparison example 3, although the hydrophobicity and the viscosity were high, there is the much amount of the residual volatile components, so that it is difficult to apply this powder to the electric or electronic materials.

TABLE 1

| | | | | Comparison | Comparison | Comparison |
|---|---|---|---|---|---|---|
| | Example 1 | Example 2 | Example 3 | example 1 | example 2 | example 3 |
| [Inorganic Oxide Powder] | | | | | | |
| Specific Surface Area | 200 | 130 | 300 | 200 | 200 | 200 |
| (m2/g) | | | | | | |
| Used Amount (g) | 100 | 100 | 100 | 100 | 100 | 100 |
| [Treating Agent] | | | | | | |
| Kinds | Octadecyl- | Hexadecyl- | Hexadecyl- | Hexyl- | Hexadecyl- | Dimethyl- |
| | trimethoxysilane | trimethoxysilane | trimethoxysilane | trimethoxysilane | trimethoxysilane | polysiloxane |
| Use Amount (g) | 30 | 20 | 40 | 30 | 30 | 20 |
| Catalyst | Triethylamine | Diethylamine | Ethylenediamine | — | — | — |
| Treating Temperature (° C.) | 200 | 250 | 300 | 200 | 120 | 300 |
| Treating time (Hr) | 1 + 1 | 1 + 1 | 1 + 1 | 1 | 1 | 1 |
| Hydrophobicity (%) | >99 | >99 | >99 | 93 | 12 | >99 |
| Volatile Components | <1 ppm | <1 ppm | <1 ppm | 12 ppm | 50 ppm | 88 ppm |
| Viscosity (Pa · s) | 342 | 311 | 297 | 62 | 50 | 311 |

### Example 4

100 g of the silica powder produced by the vapor phase method (the specific surface area was 200 m²/g by the BET method, the product name was Aerosil 200) was taken into the reaction vessel, and while stirring under the nitrogen atmosphere, the hexane solution containing 20 g of the silicone oil (the product name was KF96-50cs, produced by Shin-Etsu Chemical Co., Ltd.) was sprayed. The stirred silica powder in said vessel was heated and stirred at 300 degree C. for 20 minutes. Then, the surface modified silica powder was prepared. Furthermore, said surface modified silica powder was taken into the reaction vessel again and was heated to remove the volatile components at 200 degree C. for 60 minutes while flowing the nitrogen. The amount of the residual volatile components of the obtained surface modified silica powder was 8 ppm.

### Example 5

The surface modified silica powder was prepared by the same process as Example 1 excepting; using the hexane solution containing 100 g of the silica powder produced by the vapor phase method (the specific surface area was 130 m²/g by the BET method, the product name was Aerosil 130) and 10 g of octadecyltrimethoxysilane; and heating and stirring at 250 degree C. for 20 minutes. Furthermore, said surface modified silica powder was taken into the reaction vessel again, and was heated to remove the volatile components at 200 degree C. for 60 minutes under the nitrogen atmosphere. The amount of the residual volatile components of the obtained surface modified silica powder was 6 ppm.

### Example 6

The surface modified silica powder was prepared by the same process as Example 1 excepting; using the hexane solution containing 100 g of the silica powder produced by the vapor phase method (the specific surface area was 380 m²/g by the BET method, the product name was Aerosil 380) and 30 g of the silicone oil (the product name was KF96-50cs, produced by Shin-Etsu Chemical Co., Ltd.); and heating and stirring at 300 degree C. for 20 minutes. Furthermore, said surface modified silica powder was taken into the reaction vessel again and was heated and stirred to remove the volatile components at 200 degree C. for 120 minutes under the nitrogen atmosphere. The amount of the residual volatile components of the obtained surface modified silica powder was 8 ppm.

### Example 7

100 g of the silica powder produced by the vapor phase method (the specific surface area was 200 m²/g by the BET method, the product name was Aerosil 200) was taken into the reaction vessel, and while stirring under the nitrogen atmosphere, the mixed solution comprising 20 g of the silicone oil (the product name was KF96-50cs, produced by Shin-Etsu Chemical Co., Ltd.), 4.5 g of decyltrimethoxysilane, and 0.1 g of diethylamine was sprayed. The stirred silica powder in said vessel was heated and stirred to remove the volatile components at 200 degree C. for 120 minutes. Then, the surface modified silica powder was prepared. The amount of the residual volatile components of the obtained surface modified silica powder was 8 ppm.

### Comparison Example 4

100 g of the silica powder produced by the vapor phase method (the specific surface area was 200 m²/g by the BET method, the product name was Aerosil 200) was taken into the reaction vessel, and while stirring under the nitrogen atmosphere, the hexane solution containing 20 g of the silicone oil (the product name was KF96-50cs, produced by Shin-Etsu Chemical Co., Ltd.) was sprayed. The stirred silica powder in said vessel was heated and stirred at 300 degree C. for 20 minutes. Then, the surface modified silica powder was prepared. The amount of the residual volatile components of the obtained surface modified silica powder was 95 ppm.

### Comparison Example 5

100 g of the silica powder produced by the vapor phase method (the specific surface area was 130 m²/g by the BET method, the product name was Aerosil 130) was taken into the reaction vessel, and while stirring under the nitrogen atmosphere, the hexane solution containing 10 g of octadecyltrimethoxysilane was sprayed. The stirred silica powder in said vessel was heated and stirred at 300 degree C. for 20 minutes. Then, the surface modified silica powder was prepared. The amount of the residual volatile components of the obtained surface modified silica powder was 70 ppm.

### Comparison Example 6

100 g of the silica powder produced by the vapor phase method (the specific surface area was 380 m²/g by the BET method, the product name was Aerosil 380) was taken into the reaction vessel, and while stirring under the nitrogen atmosphere, the hexane solution containing 30 g of the silicone oil (the product name was KF96-50cs, produced by Shin-Etsu Chemical Co., Ltd.) was sprayed. The stirred silica powder in said vessel was heated and stirred at 300 degree C. for 20 minutes. Then, the surface modified silica powder was prepared. The amount of the residual volatile components of the obtained surface modified silica powder was 85 ppm.

TABLE 2

| | | | | | Comparison | Comparison | Comparison |
|---|---|---|---|---|---|---|---|
| | Example 4 | Example 5 | Example 6 | Example 7 | example 4 | example 5 | example 6 |
| [Inorganic Powder] | | | | | | | |
| Specific Surface | 200 | 130 | 380 | 200 | 200 | 130 | 380 |
| Area | | | | | | | |
| Used Amount | 100 g | 100 g | 100 g | 100 g | 100 g | 100 g | 100 g |
| [Treating Agent] | | | | | | | |
| Kinds | Silicone oil | Octadecyl- | Silicone oil | Silicone oil 20 g | Silicone oli | Octadecyl- | Silicone oil |
| | | trimethoxysilane | | Decyltrimethoxy- | | trimethoxysilane | |
| | | | | silane 4.5 g | | | |
| Used Amount | 20 g | 10 g | 30 g | Diethylamine 0.1 g | 20 | 10 | 30 |
| First heat treatment | 300° C. | 250° C. | 300° C. | 350° C. | 300° C. | 300° C. | 300° C. |
| Time | 20 minutes | 20 minutes | 20 minutes | 20 minutes | 20 minutes | 20 minutes | 20 minutes |
| Second heat | 200° C. | 200° C. | 200° C. | 200° C. | — | — | — |
| treatment | | | | | | | |
| Time | 60 minutes | 60 minutes | 120 minutes | 120 minutes | — | — | — |
| Volatilized Amount | 8 ppm | 6 ppm | 8 ppm | 8 ppm | 95 ppm | 70 ppm | 85 ppm |

(Note)
Specific Surface Area is the value by the BET method (m²/g)

1. A surface modified inorganic oxide powder, wherein the amount of residual volatile organic components is less than 30 ppm.

2. The surface modified inorganic oxide powder according to claim 1, wherein the amount of the residual volatile organic components is reduced to less than 30 ppm by heat treatment after the surface modification at a temperature of from higher than the volatilization temperature of the organic volatile components to lower than the decomposition temperature of a treating agent for surface modifying.

3. The surface modified inorganic oxide powder according to claim 2, wherein the volatile components on the powder surface are removed by the heat treatment at from higher than 200 degree C. to lower than 400 degree C. at the time of a surface treatment and the further heat treatment at from higher than 150 degree C. to lower than 400 degree C.

4. A surface modified inorganic oxide powder, wherein the amount of the residual volatile organic components is reduced to less than 30 ppm by the surface treatment with the use of a treating agent obtained by dissolving a long-chain alkylsilane together with a catalyst.

5. The surface modified inorganic oxide powder according to claim 4, wherein the surface treatment is carried out with the use of a diluted treating agent in which the long chain alkylsilane having more than 16 carbon atoms is dissolved together with an amine catalyst.

6. The surface modified inorganic oxide powder according to claim 5, wherein the surface treatment is carried out with the use of the treating agent obtained by diluting the long-chain alkylsilane from 2 to 6 times.

7. The surface modified inorganic oxide powder according to claim 4, wherein the surface treatment is carried out by existing the treating agent on the surface of the inorganic oxide powder and heating at higher than 200 degree C.

8. The surface modified inorganic oxide powder according to claim 1, wherein the amount of the residual volatile organic components is less than 10 ppm.

9. The surface modified inorganic oxide powder according to claim 1, wherein the inorganic oxide powder is silica, titania, alumina, or composite oxide particles comprising one or more these oxides.

10. The surface modified inorganic oxide powder according to claim 1, wherein the surface treatment is carried out with the use of at least one alkylsilane represented by the following formula [1], [2], [3], or [4]: 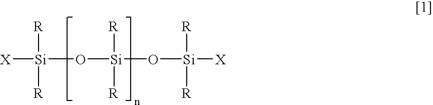
wherein R represents a hydrogen atom or an alkyl group which may be optionally substituted partially by a vinyl group, a phenyl group, a polyether group, a epoxy group or an amino group, R bonding to each Si may be the same or different, X represents the R, a halogen atom, a hydroxyl group, or a hydrolysable alkoxy group, n represents an integer of 15 to 500
RSiX₃ [2]
R¹R²SiX₂ [3]
R¹R²R³SiX [4]
wherein, R represents an alkyl group, and X represents a halogen atom, a hydroxyl group, or an alkoxy group, wherein R¹, R², and R³ in formula [3] and [4] may be the same or different, and wherein at least one of them has more than 6 carbons preferably.

11. A polar resin composite obtained by mixing a urethane resin, an epoxy resin, an acrylic resin, an unsaturated polyester resin, a vinyl ester resin, or a silicone modified resin with the surface modified inorganic oxide powder according to claim 1, wherein the content of the modified powder is less than 50% by weight.

12. The polar resin composite according to claim 11, wherein the composite is used as an adhesive or a sealant.
